(19) United States
(12) Patent Application Publication
(10) Pub. No.: US 2024/0009863 A1
(43) Pub. Date: Jan. 11, 2024

(54) DEVICES AND METHODS FOR AUTOMATED PICK AND PLACE SORTATION

(71) Applicant: Pickle Robot Company, Cambridge, MA (US)

(72) Inventors: Christopher M. Fitch, Arlington, MA (US); Andrew Meyer, Cambridge, MA (US); Daniel J. Paluska, Bath, ME (US)

(73) Assignee: Pickle Robot Company, Cambridge, MA (US)

(21) Appl. No.: 18/246,787

(22) PCT Filed: Oct. 1, 2021
(86) PCT No.: PCT/US21/53208

§ 371 Date: Mar. 27, 2023

Related U.S. Application Data
(60) Provisional application No. 63/086,859, filed on Oct. 2, 2020.
(60) Provisional application No. 63/086,878, filed on Oct. 2, 2020.

(51) Int. Cl. B25J 15/06; B25J 19/02

(52) U.S. Cl. CPC B25J 15/0616; B25J 19/02

(57) ABSTRACT

A robotic arm end effector and associated methods for picking up parcels, packages or other objects from a surface or picking space and delivering them to a sort cabinet or another destination combines at least a gripping element with an extendable support element. When in picking position, the gripping element is pointed in a downward orientation and the extendable support element is retracted. Once an object has been secured with the gripping element, the entire head may be turned upside down, a position that allows the support element to extend in such a way that it can accept the weight of the object. The object may then be transferred into one of the waiting cabinet bins, for example by tipping or tossing.

### PRIORITY CLAIM

The present invention is related to, and claims priority from, U.S. Provisional Patent Application Ser. No. 63/086,859 and Provisional Patent Application Ser. No. 63/086,878, both filed on Oct. 2, 2020, the disclosures of which are hereby incorporated by this reference in their entireties.

### FIELD OF THE INVENTION

The present invention is directed to robotic end effectors, and in particular, end effectors for sorting parcels to multi-spot destination cabinets as well as methods for robotic sortation, and in particular, methods for automatically picking objects and placing them into some receptacle.

### BACKGROUND OF THE INVENTION

In the warehouse logistics industry, there is a push for the use of robotics guided by artificial intelligence algorithms to move and sort packages. This is a continuation of a general trend of automation in industry and reflects both economic and social pressures to give physically difficult jobs to machines to perform instead of humans. Within the package handling arena there are various subcategories of automation. The current application is concerned with pick-and-place automation, in which a robot picks up a parcel or package and delivers it to a sort destination, for example, a cabinet with cubbies, chutes, bins, or other receptacle arrangements.

Current systems often use multiple robotic arms or multiple end effectors to perform pick-and-place automation. In these known systems, one robotic arm or end effector will perform a pick operation and then hand off or transition to a second robotic arm or a second end effector to perform a place operation. Known systems require two robotic arms or end effectors because neither the arm nor the end effector is sufficiently versatile to perform both pick operations and place operations.

Pick and place operations are challenging for current systems for a number of reasons. Picking difficulties include variable package size, variable package material and quality, and lack of consistent package orientation. For example, package materials include cardboard, plastic bags, bubble bags and more, and may be brand new, worn down from use, or damaged; and packages may be oriented such that they are tilted, rotated, or partially covered by another package.

Existing placing systems are confined almost exclusively to an environment with a uniform pallet whose dimensions are known, where all packages to be placed are identical, and where packages are tiled in a regular grid. By contrast, most real world logistics operations need to deal with a variety of package types and sizes, meaning as packages are placed, they create and build up an irregular surface. Placing packages onto this irregular surface is challenging. Having some force feedback, sensing, and compliance in the end effector, as described herein, greatly increases the chances of success.

It is often desirable to deploy a robot into existing infrastructure such as a preexisting warehouse configuration. Using an existing facility with minimal modification reduces the capital expenditure of implementing an automated solution. However, the physical constraints of existing infrastructure, which were designed for humans, can be a challenge for a robot to negotiate. For instance, getting a robot to approach a sort destination at the proper angle for placing or tossing can require some contortion and furthermore some choice between various possible contortions of the robot arm. The same is true for picking. These factors complicate the problem because they require the system to choose a solution about what path to take to approach or deliver a package without colliding with existing obstacles.

### SUMMARY OF THE INVENTION

In one embodiment, a robotic arm end effector for picking up parcels or packages from a surface or picking space and delivering them to a sort cabinet or another destination combines at least a gripping element with an extendable support element, with further assistance provided by various sensing means. This arrangement allows the end effector to adjust to the needs of either a picking task or a placing task without the need for a second robotic arm or second end effector. When in picking position, the extendable support element is retracted to a position that is far enough above the gripping surface to minimize collision hazard with neighboring packages or other edges that may protrude into the picking space. Once a package has been secured with the gripping element, the entire head can be turned upside down, a position that now allows the support element to extend in such a way that it can accept the weight of the package. As the gripping element is released, the package is transferred from the gripping element to the now extended support element. The package can now be transferred into one of the waiting cabinet bins, for example by tipping or tossing.

The picking space may comprise a substantially horizontal surface such as a table or flat conveyor belt or any number of other arrangements, such as an inclined carousel surface. The sorting destination may comprise a substantially vertical cabinet with sorting bins or any number of other arrangements.

In another aspect, this application discloses a method and means for picking up packages from a picking space and delivering them to sort destinations combines a robotic arm, an end effector, and a strategy. The strategy involves several steps: (1) identifying a good pick candidate; (2) gripping the pick candidate (such as a package) with a gripper element (such as a suction device); (3) manipulating the package 180 degrees to an upside down position; (4) extending a support element or surface to engage and support the package while the gripper is released; and (5) delivering the package to the sort destination, such as by tossing or tilting the package into a sort bin.

Other currently available solutions for this automation category do not address the current need for a flexible system that uses a single robotic arm for both pick and place operations on existing infrastructure. For example, one current method is to pick up a package using a suction-based end effector and simply try to place the package in the desired target bin using the suction device alone at a 90 degree orientation from its pick position. While this strategy works for some packages, it does not work for wide thin packages that need to go into relatively narrow destination bin openings, because the wide dimensions, when oriented at 90 degrees, can prevent the package from fitting into the destination bin. In such a scenario neither does it work to rotate the package a full 180 degrees because a suction head that is small enough to pick up the package from a crowded pick location may be too small to support the package upside down by itself when the suction is removed. In addition, the pick location may not be in the center of gravity, in which case the package will fall. Nor can the arm reach into the bin because of space constraints. A common industry solution to these difficulties is to replace the infrastructure with new sort cabinets that fit the robot's capabilities, instead of the reverse.

Another example involves an end effector that has a mini conveyor belt on it that delivers a package easily into narrow bin openings but has no way of picking up a package by itself and relies on another robotic arm or other means to place the package on the mini conveyor.

Another example uses different end effector tool heads for each task and has a means for quickly changing the tool head.

Furthermore, none of the above examples have been shown to be able to toss a package through a narrow opening so that it lands toward the rear of a cabinet bin, even if there are packages in the foreground of the bin. The ability to use the airspace above already sorted packages helps to optimize the spatial distribution of the packages in the bin to maximize its capacity.

Several advantages of the invention disclosed herein are as follows, although the list is not meant to be exhaustive: first, only a single end effector and single robotic arm is needed to achieve both pick and place tasks, allowing for one smooth motion to deliver a package from picking surface to sort cabinet destination; second, it allows a single end effector to present a small profile into the pick pile without needing to attach to a package at its center of gravity while providing means of support to the package when it is inverted; third, the inverted package is fully supported, but free to slide into its sortation destination when the gripping element is released; and fourth, a package can additionally be tossed into its sort destination, allowing more efficient stacking of packages in cubbies and chutes, because it can thereby deliver a thin package over another thin package in the foreground.

### BRIEF DESCRIPTION OF THE DRAWINGS

FIG. 1 shows an exploded isometric view of an end effector, constructed in accordance with the invention, showing a gripping element, a mechanism for extending and retracting a support element, a rubber bumper with integrated lighting, and an assortment of sensors.

FIG. 2 shows the end effector from the side with its support element in retracted position.

FIG. 3 shows the end effector from the side, inverted, with its support element in extended position.

FIG. 4 shows an end effector from the side, inverted, with its support element in extended position, in an alternate embodiment of the invention that has curved track slots, allowing the support element to follow more axes of movement.

FIG. 5 is an overall perspective view of the end effector in “placing” position, with the support element in its extended position.

FIG. 6 shows a robotic arm with an end effector in accordance with an embodiment of the invention attached to its end in its retracted, or “picking” position, picking up a parcel from a horizontal picking surface, with a vertical sortation cabinet waiting to the left.

FIG. 7 shows a robotic arm with an end effector in accordance with an embodiment of the invention attached to its end in its extended, or “placing” position, about to deliver the parcel to a waiting sortation cabinet.

FIG. 8 is a three-dimensional rendering of an automated pick-and-place work cell showing a horizontal picking surface, robotic arm, end effector, package, and vertical sort cabinet.

FIG. 9 is another rendering of the same work cell showing the robotic arm in its placing position, as it approaches the vertical sort cabinet with a package, now supported on the inverted end effector.

FIG. 10 shows the robotic arm about to toss a package into a bin, over the top of thin packages in the front portion of the bin.

FIG. 11 shows the robotic arm about to toss a package into a bin from a different perspective.

### DETAILED DESCRIPTION OF THE INVENTION

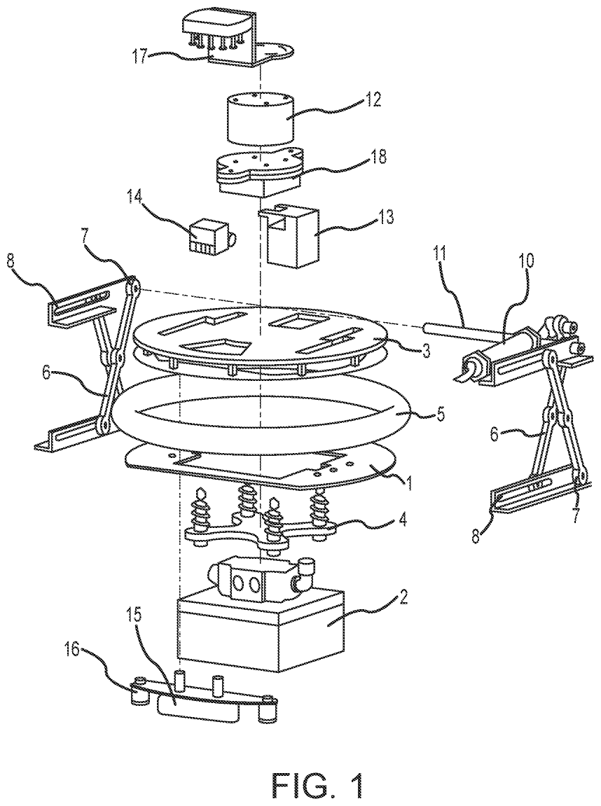

FIG. 1 depicts an exploded isometric view of an embodiment of the invention. The end effector depicted in FIG. 1 includes support element 1, which is configured to extend toward or retract away from the gripping element 2. The main plate 3 serves as the foundation of the gripping head, to which all the other components are attached. Gripping element 2 is attached to the assembly via spring cushion plate 4. In some embodiments, the gripping element comprises a suction or vacuum gripper. The perimeter of the end effector is protected by rubber bumper 5 with integrated lighting to signal to nearby workers the current status of the robot or other messages. Status lighting may be implemented, for example, with RGB LEDs.

Scissor linkage arms 6 are connected to the system such that for each of them, one end has one axis of rotation 7, and the other is slidably attached to a track slot 8. The support element 1 is extended and retracted via double-acting pneumatic piston 10, which drives scissor linkage arms 6 via drive axle 11. This arrangement allows support element 1 to move up and down (with respect to the orientation of the end effector in FIG. 1) from “pick” position to “place” position and back again.

Sensors 12, 13, and 14 provide real-time feedback for algorithmic control of the robot arm. Illumination elements 16 and imaging and depth sensor(s) 15 add visual and depth perception input. Illumination elements 15 may be, for example, LED lights. Imaging and depth sensor(s) 15 may be, for example an RGBD camera.

Cable harness bracket assembly 17 secures the cable harness (not shown) that feeds power to the end effector and fits onto the tool head of a robotic arm (also not shown). A quick-connect device quick-change connector 18 attaches the tool head to the main plate 3.

One of the sensors that support the picking algorithm may be an analog laser range finder, which may facilitate a number of functions: (1) locating the edges of a parcel; (2) measuring the distance between the end effector and the parcel; (3) differentiating between soft packages and hard packages; and (4) determining the center of parcel surface.

Locating the range finder in the middle of the suction head registers its measurements to the head in an axially symmetrical way. This means that no matter what orientation the end effector is relative to the parcel it is picking, the measurement will be the same and accurate, since it is related to the surface directly below the center of the suction head. If the range finder were located to the side of the suction head, then there is a risk of discrepancy between what the sensor sees and what the suction head encounters. Furthermore, that discrepancy can change depending on the axial position of the end effector relative to the parcel, opening the door to more risk of error.

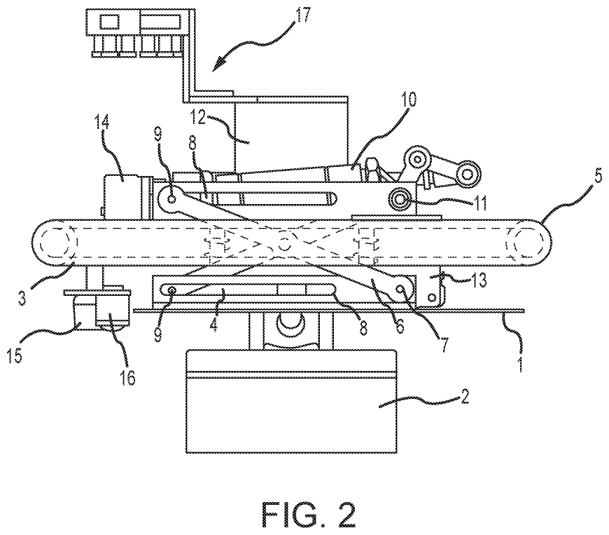

FIG. 2 is a side view of the same embodiment assembled and in its retracted, or “picking” position. Gripping element 2 is oriented downward and attached to main plate 3 (which is hidden within rubber bumper 5 in this orientation) via a spring cushion plate 4 to help absorb vertical displacement. Support element 1 is attached to an extendable mechanism assembly that consists of a pair of scissor lifts, with arms 6 driven by double-acting pneumatic piston 10 through a drive shaft 11 that connects the two pairs of arms. The arms are each pivotally connected at one end 7 and slidably connected at the other end 9 to track slots 8 and pivotally connected to each other at their centers. As shown here in its retracted position, the support element 1 is tucked back out of the way of the gripping element 2 when the end effector is in picking position. Rubber bumper 5 protects the perimeter of the tool space and integrated lighting permits messaging to nearby humans. Illumination of the picking space is provided with illumination elements 16 for improved operation of imaging and depth sensor(s) 15. Sensor support is also provided by a force torque sensor 12, analog laser range finder 13, and vacuum/pressure sensor 14. Cable harness bracket assembly 17 helps secure and guide power cables and vacuum/pneumatic lines into the tool space.

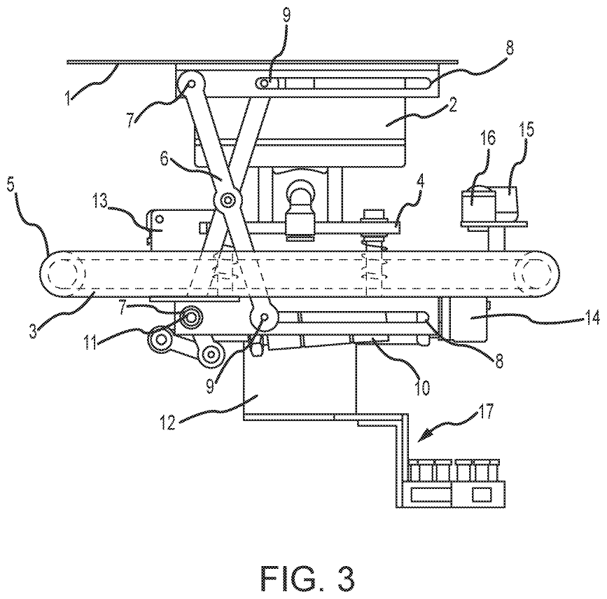

FIG. 3 shows the same embodiment of the end effector in its extended, or “placing” position. Here the robotic arm (not shown) has flipped the tool head and end effector 180 degrees, such that gripping element 2 is now oriented upward. Support element 1 has now accepted the burden of a parcel (not shown) so the gripping element may be released and the parcel is free to be placed into a sortation bin, for example, by tossing or tipping. Because scissor link arms 6 are of equal length and the track slots 8 are parallel and horizontal, the linkage guides the support element along a vertical axis, allowing a tight clearance around the central mass of the gripping element as the support element is extended.

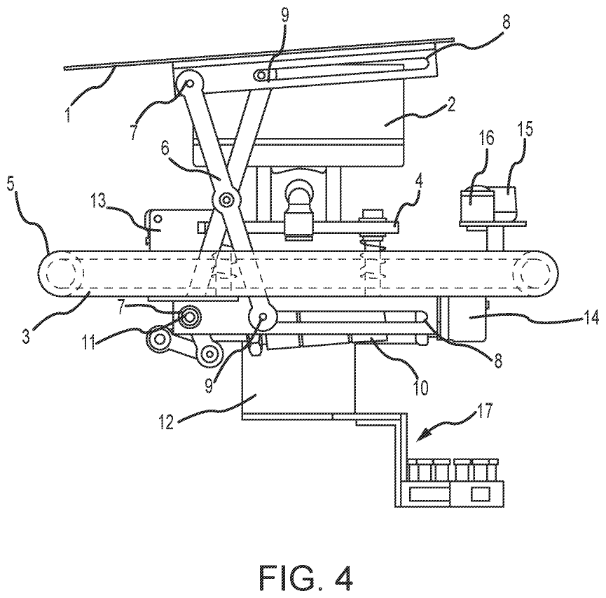

FIG. 4 shows another embodiment of the end effector. In this embodiment, the shapes of the tracks 8 are changed slightly to alter the trajectory of the support element as it is driven upward. This view is a similar view to the previous, except in this embodiment, the shape of upper track 8 has been bent slightly, such that when track following end 9 of linkage arm 6 is forced into the bent section, the support element pivots around upper pivot 7. Similarly, lower track 8 can also be bent (not shown) to pivot the entire linkage and support element around drive axle 11, in order to be able to follow through a “tossing” motion of the robot arm.

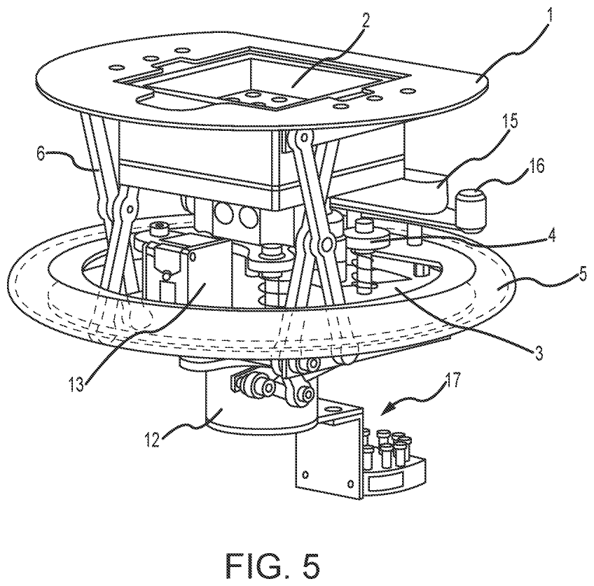

FIG. 5 shows a perspective angled view from above of the embodiment of FIGS. 1-3 with the support element in the “placing” position. In FIG. 5, the interior cavity of gripping element 2 is visible. Also visible is the position of support element 1 just above the lip of the gripping element, ready to accept the weight of a parcel. Analog laser range finder 13 is shown placed off-center to clear the central bulk of the gripping element. However, the range finder can also be placed in the center of the gripping element to facilitate sensing. Spring cushion plate 4 absorbs vertical forces applied to the gripping element by allowing spring-tensioned motion along the vertical axes of four shoulder bolts.

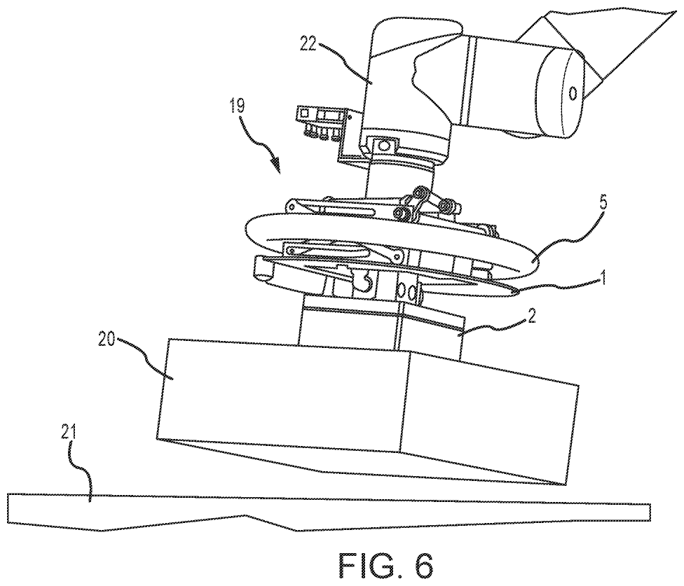

FIG. 6 shows a typical use scenario of a robotic arm 22 with an end effector assembly 19 according to an embodiment of this invention attached in “pick” mode, with support element 1 in its retracted position and gripping element 2 attached to a parcel 20 that it has just picked off of a pick surface 21.

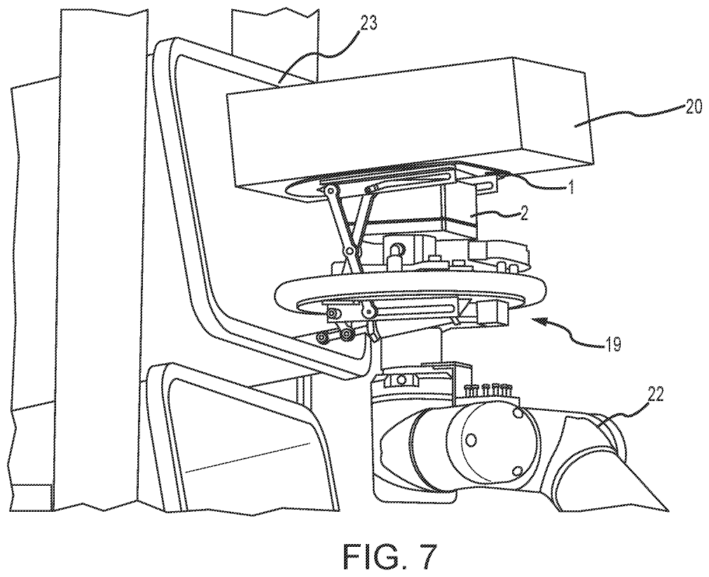

FIG. 7 shows a typical use scenario of a robotic arm 22 with an end effector assembly 19 in “place” mode. Here is shown how support element 1 is now supporting parcel 20 after gripping element 2 has been released, readying the parcel for placement into a vertical sortation cabinet 23, for example by tipping or tossing.

In the context of a second aspect, a robotic arm has an end effector on it that has at least a gripping element and an extendable support element, with a variety of possible additional elements, including, but not limited to, range sensor, vacuum/pressure sensor, RGBD camera and/or LiDar. Using sensors and algorithms to guide its motions, the robot uses the gripping element of its end effector to pick up a package from a picking surface. The package can be, for example, any standard shipping unit—envelope, box, or soft pack—and can be oriented in any direction, singulated or in great heaps. In its picking position, the extendable support element is retracted, so as to not pose a collision hazard when “nosing” in among packages. Once the gripping element has secured a good pick candidate, it lifts the package and rotates it a full 180 degrees from the horizontal. In this inverted position, the support element can then be extended upward to take the weight of the package as the gripping element is released. Once the gripping element releases the package, it is free to be delivered into the sorting bin by tipping or tossing.

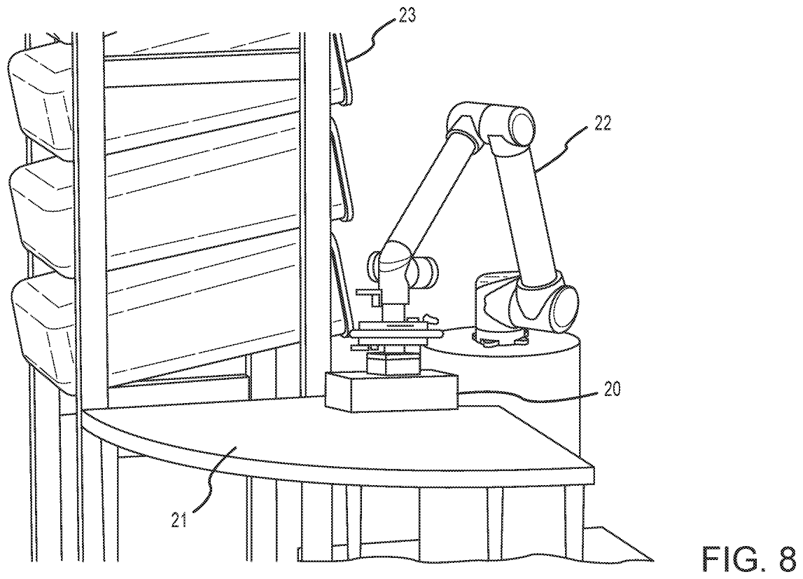

FIG. 8 shows an exemplary automated pick-and-place work cell showing a package 20, a horizontal picking surface 21, a robotic arm 22, and a vertical sort cabinet 23. In this view, robotic arm 22 is conducting a picking operation from picking surface 21. Robotic arm 22 has engaged its gripping element, which in this embodiment is a suction gripper as part of the end effector, to pick up package 20. The end effector is oriented such that the gripping element is pointed in a predominantly downward direction. The support element is retracted and plays no active role in the picking operation.

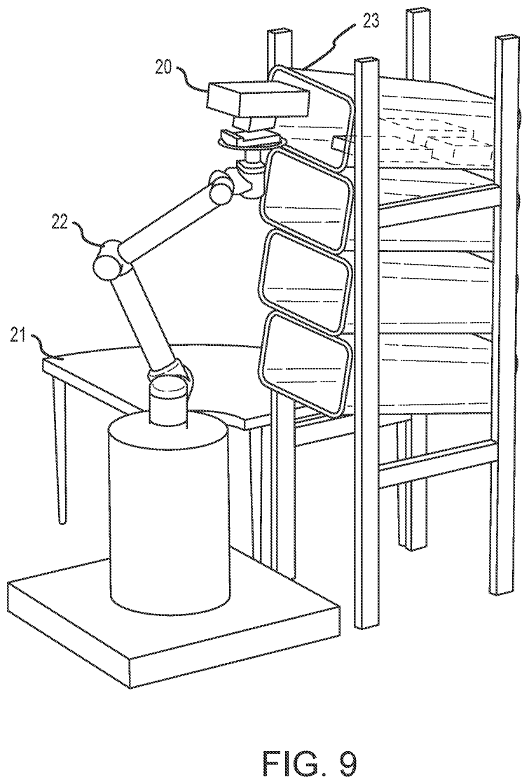

FIG. 9 is another rendering of the same work cell showing the robotic arm 22 in its placing position, as it approaches the vertical sort cabinet 23 with a package 20, now supported on the inverted end effector. With the gripping element engaged, the robotic arm 22 has inverted the end effector such that the gripping element is now oriented in a predominantly upward direction. The support element has been extended to remove the package from the gripping element and support the package.

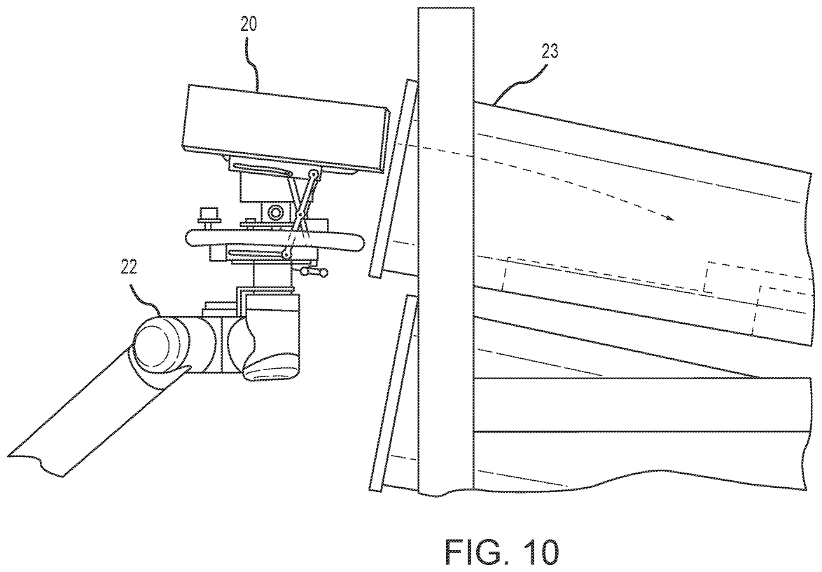

FIG. 10 shows the robotic arm about to toss a package into a bin, over the top of thin packages in the front portion of the bin. The bin is shown in cross-section in order to see packages already inside. Existing placement systems do not reliably use the full height of a sortation cabinet and may consider a sortation destination full when packages lay in a single layer from the back to the front of the sortation destination. The systems and methods of this disclosure use more of the space in the destination by tossing packages on top of packages that have already been placed.

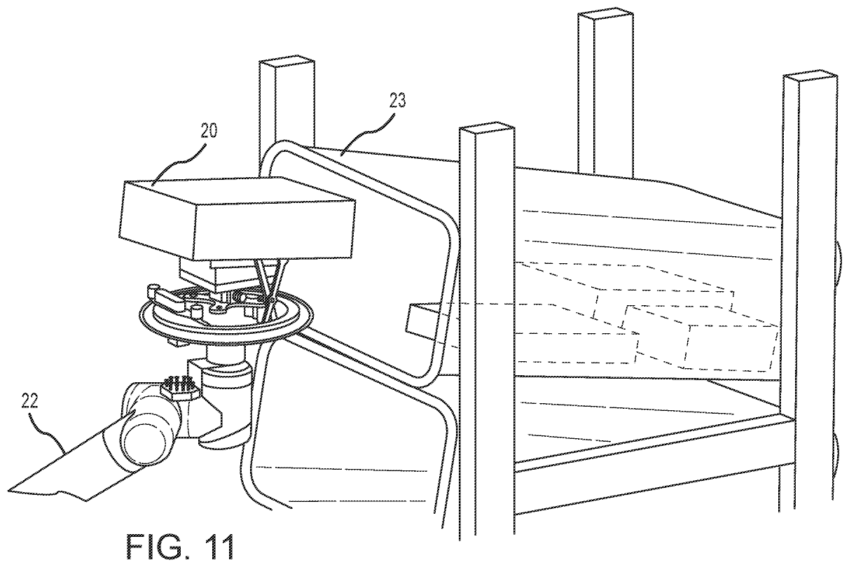

FIG. 11 shows the robotic arm about to toss a package into a bin from a different perspective. As can be seen, absent a tossing motion, the robot arm may consider the sortation destination full because package 20 will not fit between the edge of the sortation destination and the package nearest that edge.

It should be noted that all of the various steps from picking to placing are accomplished by the robot arm in one smooth motion, which gathers momentum into the package as it is tossed into the cabinet bin, ensuring that it lands as far back in the stack as possible. In this way, optimal stacking is achieved.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination features. In particular, with reference to the appended claims, features from dependent claims may be combined with those of the independent claims and features from respective independent claims may be combined in any appropriate manner and not merely in the specific combinations enumerated in the appended claims.

Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow. For example, while the invention has been described with respect to parcels or packages and in the context of sortation cabinets, it will be understood that the principles of this invention apply equally to many types of objects to be picked and many types of placement destinations.

1. A robotic arm comprising:
an end effector with a gripping element and a support element,
wherein the support element is capable of retracting to a first position and extending to a second position, wherein in the first position, the support element is disposed some distance away from the gripping element and does not interfere with the operation of the gripping element, and wherein in the second position, the support element is disposed near the gripping element and may lift or support an object engaged by the gripping element.

2. The robotic arm of claim 1 wherein the robotic arm is configured to orient the end effector such that the gripping element points in a predominantly downward direction during a picking operation.

3. The robotic arm of claim 2 wherein the robotic arm is further configured to retract the support element to the first position during the picking operation.

4. The robotic arm of claim 1 wherein the robotic arm is configured to orient the end effector such that the gripping element points in a predominantly upward direction during a placing operation.

5. The robotic arm of claim 4 wherein the robotic arm is further configured to extend the support element to the second position and disengage the gripping element when the support element is extended into the second position during the placing operation.

6. The robotic arm of claim 5 wherein the robotic arm is further configured to conduct the placing operation by a dynamic movement of one or more of the robotic arm, end effector, and support element that results in tossing an object from the support element into a target sort location.

7. The robotic arm of claim 1 wherein the gripping element is a suction device.

8. The robotic arm of claim 7 wherein the end effector further comprises a distance sensor.

9. The robotic arm of claim 8 wherein the distance sensor is disposed in the middle of the suction head of the suction device.

10. A method performed by a robotic arm to pick an object from a picking surface and place an object in a sorting destination, comprising the steps of:
identifying an object disposed on the picking surface as a pick candidate;
gripping the pick candidate with a gripping element of an end effector attached to the robotic arm;
manipulating the end effector to an upside down position;
extending a support element to engage and support the object while the gripping element is released; and
delivering the object from the support element to the sorting destination.

11. The method of claim 10, wherein the step of delivering the object from the support element to the sorting destination further comprises tossing the object into a sort bin.

12. The method of claim 11, wherein the step of delivering the object from the support element to the sorting destination further comprises using the momentum of the end effector and the package to toss the object into the sort bin.

13. The method of claim 10, wherein the step of delivering the object from the support element to the sorting destination further comprises tilting the object into a sort bin.

14. The method of claim 10, wherein the step of gripping the pick candidate comprises disposing the end effector into a gripping position and wherein the step of manipulating the end effector to an upside down position comprises rotating the end effector substantially 180 degrees from the gripping position.

15. The method of claim 14, wherein the step of rotating the end effector substantially 180 degrees from the gripping position comprises rotating the end effector between 150 degrees and 210 degrees from the gripping position.

16. A robotic system comprising:
a robotic arm with an end effector, wherein the end effector comprises a gripping element and a support element;
a picking surface; and
a sorting destination;
wherein the robotic arm is configured to
pick up an object using a gripping element while the end effector is in a first orientation, and
rotate the end effector into a second orientation and extend the support element such that the object may be supported by the support element.

17. The robotic system of claim 16 wherein the robotic arm is further configured to deliver the object from the support element to the sorting destination by tossing the object from the support element.

18. The robotic system of claim 14 wherein the picking surface comprises any one of a table, a flat conveyor belt, or an inclined carousel surface.

19. The robotic system of claim 16 wherein the sorting destination comprises a substantially vertical cabinet with sorting bins.

20. The robotic system of claim 16 wherein the gripping element comprises a suction device.

21. The robotic system of claim 20 wherein the end effector further comprises a distance sensor.

22. The robotic system of claim 21 wherein the distance sensor is disposed in the middle of the suction head of the suction device.
